(19) United States
(12) Patent Application Publication
(10) Pub. No.: US 2016/0358463 A1
(43) Pub. Date: Dec. 8, 2016

(54) INTEGRATED CONTROL APPARATUS OF INTELLIGENT TRANSPORTAION SYSTEM (ITS) DEVICE AND INTEGRATED CONTROL SYSTEM OF ITS DEVICE

(71) Applicant: ITS Korea, Gyeonggi-do (KR)

(72) Inventors: Yong Seong CHO, Gyeonggi-do (KR); Seung Nyeo SON, Gyeonggi-do (KR)

(21) Appl. No.: 14/752,675

(22) Filed: Jun. 26, 2015

(30) Foreign Application Priority Data
Jun. 2, 2015 (KR) 10-2015-0078198

(51) Int. Cl. G08G 1/01; G08G 1/08; G08G 1/017

(52) U.S. Cl. CPC G08G 1/0145; G08G 1/0175; G08G 1/0125; G08G 1/08

(57) ABSTRACT

An integrated control device of ITS device comprising an element device controller including a plurality of element device control modules, the element device control modules configured to perform an operation set in advance based on a traffic image signal provided from at least one image acquisition device; and an integrated controller configured to monitor the element device control modules and configured to generate a traffic management strategy to control a traffic flow in some areas based on the operation of the element device control modules.

### CROSS-REFERENCE TO RELATED APPLICATION(S)

This application claims priority under 35 USC §119 to Korean Patent Application No. 10-2015-0078198, filed on Jun. 2, 2015 in the Korean Intellectual Property Office (KIPO), the contents of which are incorporated by reference herein in its entirety.

### BACKGROUND

1. Technical Field

Example embodiments of the inventive concept relate to a traffic control system. More particularly, embodiments of the present inventive concept relate to an integrated control apparatus of an intelligent transportation system (ITS) device and integrated control system of ITS device.

2. Description of the Related Art

Recently, a various intelligent transportation system (ITS) device such as an automatic vehicle identification (AVI), a vehicle detector (VDS), a dedicated short range communication (DSRC), a variable message sign (VMS) and an illegal parking crackdown system have been developed.

Generally, five through eight ITS devices are installed in some areas, and controllers of the ITS devices are individually installed in accordance with the ITS devices, respectively. Thereby, it causes a problem of waste of resources to duplicate a construction of the controllers. Further, according to a non-standardization of the controllers of the ITS devices, an installation and replacement of the controllers of the ITS devices. Thereby, there is an operational problem that a maintenance cost is increased.

The controllers of the ITS devices are physically large and clunky to inhibit a walking environment as well as an urban view.

Although some research and developments of integration and miniaturization of the ITS devices, the research and developments are to keep a various ITS devices in one closure and do not consider a compatibility and a functional links between the ITS devices.

### SUMMARY

Some example embodiments provide an integrated control apparatus of ITS devices capable of controlling the ITS devices integrally.

Some example embodiments provide an integrated control system of ITS devices capable of a traffic management based on a field in real-time.

According to example embodiments, an integrated control device of ITS device comprising: an element device controller including a plurality of element device control modules, the element device control modules configured to perform an operation set in advance based on a traffic image signal provided from at least one image acquisition device; and an integrated controller configured to monitor the element device control modules and configured to generate a traffic management strategy to control a traffic flow in some areas based on the operation of the element device control modules.

In example embodiments, each of the element device control modules includes one selected from among a CCTV control module which transfers the traffic image signal to an outside, an automatic vehicle identification (AVI) control module which indentifies a vehicle based on the traffic image signal, a vehicle detector (VDS) control module which analyzes a traffic volume based on the traffic image signal, a variable message sign (VMS) control module which controls an operation of a variable message sign (VMS), a traffic light control module which controls an operation of a traffic light, an illegal parking enforcement control module detecting a illegal parking vehicle, and an exclusive bus lane enforcement control module detecting a vehicle which violates an exclusive bus lane.

In example embodiments, the element device controller further includes a reset module configured to control a power which is supplied to the control modules in response to a control of the integrated controller.

In example embodiments, the integrated controller is configured to indentify each of the element device control modules and is configured to generate a control module status information by monitoring an operation of the element device control modules which is identified.

In example embodiments, the integrated controller is configured to generate the traffic management strategy based on detecting signals which is generated from the element device control modules and is configured to control a variable message signal or a traffic light selected from the element device control modules based on the traffic management strategy.

In example embodiments, the integrated control device further comprising an environmental monitoring unit which includes a sensing module to sense a temperature inside of the integrated control device and a cooling heating module to adjust an interior temperature based on a sensed temperature.

According to example embodiments, the integrated control system comprising a plurality of integrated control devices of ITS devices which are connected to a traffic information acquisition device, a traffic information display device, and a traffic information center through a network, where a n-th (where, n is an integer of 2 or more) integrated control device among a plurality of the integrated control devices includes: a communication unit configured to receive a traffic image signal provided from the traffic information acquisition device, a traffic management information provided from a integrated control device which is located adjacent to the n-th integrated control device, and a traffic control information provided from the traffic information center; an element device controller including a plurality of element device control modules, the element device control modules configured to perform an operation set in advance based on the traffic image signal; and an integrated controller configured to monitor the element device control modules and configured to generate a n-th traffic management strategy to control a traffic flow in some areas based on one selected among the operation of the element device control modules, the traffic management information, and the traffic control information.

Therefore, the integrated control apparatus of the ITS devices according to example embodiments may include an element device controller including a plurality of element device control modules, the element device control modules configured to perform an operation set in advance based on a traffic image signal provided from at least one image acquisition device; and an integrated controller configured to monitor the element device control modules and configured to generate a traffic management strategy to control a traffic flow in some areas based on the operation of the element device control modules. Therefore, the integrated control apparatus may integrally control the ITS devices. Also, the integrated controller may generate a traffic management strategy to control a traffic flow in some areas in which the ITS devices are installed based on the traffic information generated by the element device control modules. Therefore, the integrated control device may be capable of a traffic management based on a field in real-time.

The integrated control system of the ITS devices according to example embodiments may include the integrated control device. Therefore, the integrated control system of ITS devices may be capable of a traffic management based on a field in real-time.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating an integrated control system of ITS devices in accordance with example embodiments.

FIG. 2 is a diagram illustrating an example of the integrated control system of FIG. 1.

FIG. 3 is a block diagram illustrating examples of the integrated control apparatus of the ITS devices included in the integrated control system of the ITS devices of FIG. 1.

FIG. 4 is a diagram illustrating an example of the integrated control apparatus of FIG. 3.

FIG. 5 is a block diagram illustrating an example of an integrated controller included in the integrated control apparatus of FIG. 3.

FIG. 6 is a diagram for explaining a traffic management strategy which is generated by the integrated control apparatus of FIG. 3.

FIG. 7 is a flow chart illustrating an waiting vehicle caution information generated by the integrated control apparatus of FIG. 3.

### DETAILED DESCRIPTION

Hereinafter, the present invention will be explained in detail with reference to the accompanying drawings.

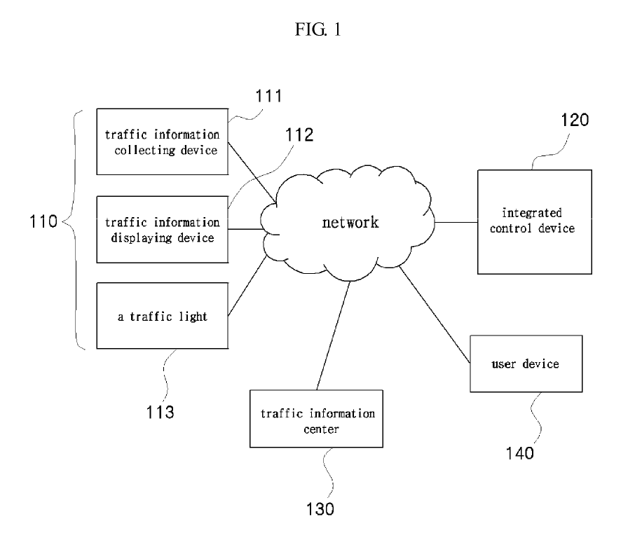

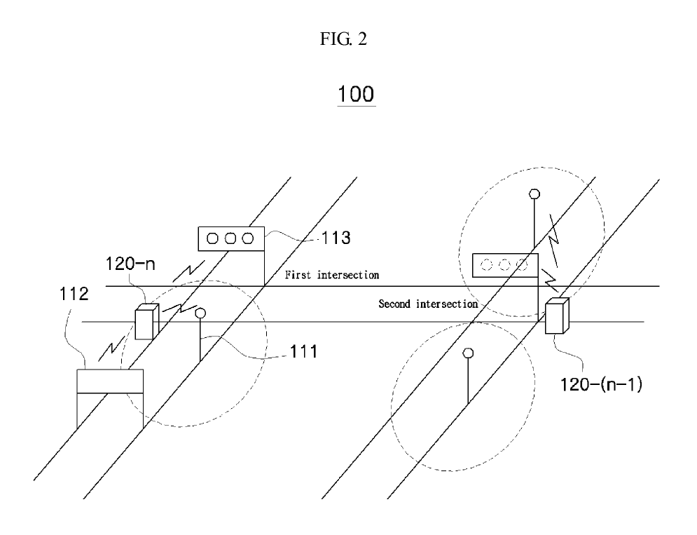

FIG. 1 is a block diagram illustrating an integrated control system of ITS devices in accordance with example embodiments. FIG. 2 is a diagram illustrating an example of the integrated control system of FIG. 1.

Referring to FIGS. 1 and 2, the integrated control system 100 of ITS devices may include an element device 110 and an integrated control device 120. The integrated control system 100 may further include a traffic information center 130 and an user device 140. Where, the element device 110, the integrated control device 120, the traffic information center 130 and the user device 140 may be connected to each other through a network or may be directly connected to each other through a near field communication.

The integrated control system 100 may be located in some areas on a road (e.g., a crossroad, a access road, a crosswalk, etc). The integrated control system 100 may collect a traffic information of the some areas, or the integrated control system 100 may display a traffic information by controlling of the integrated control device 120. The element device 110 may include a traffic information collecting device 111 (e.g., a camera), a traffic information displaying device 112 (e.g., a variable message sign (VMS)), and a traffic light 113.

In consideration of a communication distance to the integrated control device 120, the element device 110 may be located in a region of 500 m or less based on the integrated control device 120.

The integrated control device 120 may include a plurality of element device control modules to perform an operation set in advance based on a traffic image signal provided from at least one image acquisition device. The integrated control device 120 may monitor the element device control modules. The integrated control device 120 may generate a traffic management strategy to control a traffic flow in some areas in which the integrated control device 120 is installed based on detecting signals generated from the element device control modules.

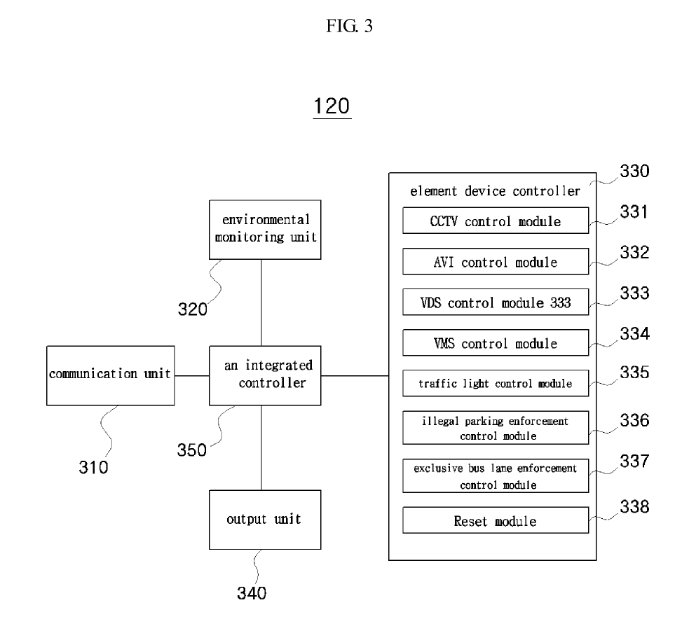

For example, the integrated control device 120 may include a vehicle detection control module which analyzes a traffic volume based on the traffic image signal collected by a camera. The integrated control device 120 may generated the traffic management strategy to dynamically control a conversion of the traffic light 113 (e.g., controlling a time of a driving traffic light) based on a traffic volume information (i.e., a detecting signal) generated by the vehicle detection control module. A specific construction of integrated control device 120 would be described with reference to FIGS. 3 through 5.

In some example embodiments, integrated control system 100 may include a plurality of integrated control devices (120-(n−1), 120-n) which are connected to the integrated control system 100 located within some areas (or, some distances).

As described in FIG. 2, integrated control system 100 may include a n-th integrated control device 120-n and (n−1)-th integrated control device 120-(n−1). Where, the n-th integrated control device 120-n may be located in a first crossroad (or, intersection) and may be connected to a traffic information collecting device 111, a traffic information displaying device 112, and a traffic light 113 located near the first crossroad via wireless communications. The (n−1)th integrated control device 120-(n−1) may be located in a second crossroad (or, intersection) and may be connected to a traffic information collecting device 111, a traffic information displaying device 112, and a traffic light 113 located near the second crossroad. Therefore, the n-th integrated control device integrated control device 120-n may independently generate a traffic management strategy of an area near the first crossroad based on a traffic information which is generated in the first crossroad, and the (n−1)-th integrated control device 120-(n−1) may independently generate other traffic management strategy of an area near the second crossroad based on a traffic information which is generated in the second crossroad,

In some example embodiments, the integrated control device 120 may receive a traffic management information from other integrated control device 120 which is located adjacent to the integrated control device 120, or may provide a traffic management information to other integrated control device 120 which is located adjacent to the integrated control device 120. For example, the (n−1)-th integrated control device 120-(n−1) may generate a (n−1)-th traffic management strategy for a reduced traffic volume in accordance with an increasing a traffic volume of the second crossroad, and the (n−1)-th integrated control device 120-(n−1) may provide the (n−1)-th traffic management strategy to the n-th integrated control device 120-n. The n-th integrated control device 120-n may generate a n-th traffic management strategy causing vehicles driving near the first crossroad to refrain from entering the second crossroad based on the (n−1)-th traffic management strategy. Where, the traffic management information may be an information to control the incident such as a flow of a traffic, an accident, a congestion of a traffic, etc. The traffic management information may include an incident information, a parking violation information, an entry vehicle caution information, a waiting vehicle caution information, a vehicle stop caution information, a changing lane information, a traffic light control information, etc.

In some example embodiments, the integrated control device 120 may receive a traffic management information from the traffic information center 130, or may provide a traffic management information to traffic information center 130. For example, the integrated control device 120 may generate a traffic management strategy to control a traffic flow in some areas based on the traffic management information from the traffic information center 130. For example, when a distance between the n-th integrated control device 120-n and the (n−1)-th integrated control device 120-(n−1) exceeds a maximum distance of communication (e.g., 500 m), a traffic management information generated by the (n−1)-th integrated control device 120-(n−1) may provide to the n-th integrated control device 120-n via the traffic information center 130.

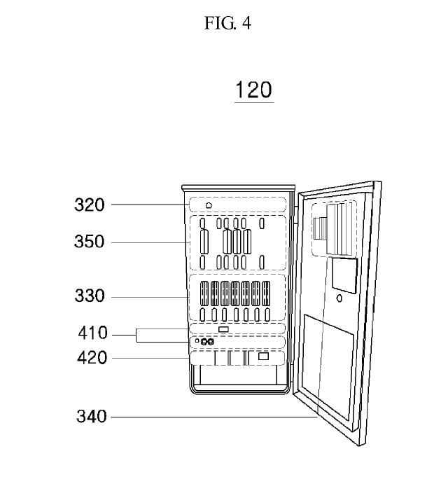

FIG. 3 is a block diagram illustrating examples of the integrated control apparatus of the ITS devices included in the integrated control system of the ITS devices of FIG. 1. FIG. 4 is a diagram illustrating an example of the integrated control apparatus of FIG. 3.

Referring to FIGS. 3 and 4, the integrated control device 120 may include a communication unit 310, an environmental monitoring unit 320, an element device controller 330, an output unit 340, and an integrated controller 350.

The communication unit 310 may receive a traffic image signal provided from the traffic information collecting device 111, a traffic management information, or a traffic control information provided from the outside. The communication unit 310 may output a traffic management information or a traffic control information internally generated. For example, the communication unit 310 may perform as a node of a network, the communication unit 310 may receive a traffic information from the element device 110 located within some areas based on the integrated control device 120, and the communication unit 310 may provide a collected traffic information to the traffic information center 130 as a parent node.

The environmental monitoring unit 320 may sense a temperature inside of the integrated control device 120 and may adjust an interior temperature based on a sensed temperature. For example, the environmental monitoring unit 320 may include a sensing module to sense a temperature inside of the integrated control device and a cooling heating module to adjust an interior temperature based on a sensed temperature. Therefore, the environmental monitoring unit 320 may control the integrated control device 120 to operate stably. The sensing module may sense whether a locking of a door included in the integrated control device 120 for protecting components in the integrated control device 120.

The element device controller 330 may include a plurality of element device control modules to perform an operation set in advance based on a traffic information. As illustrated in FIG. 3, the element device controller 330 may include a CCTV control module 331 which transfers the traffic image signal to an outside, an automatic vehicle identification (AVI) control module 332 which indentifies a vehicle based on the traffic image signal, a vehicle detector (VDS) control module 333 which analyzes a traffic volume based on the traffic image signal, a variable message sign (VMS) control module 334 which controls an operation of a variable message sign (VMS), a traffic light control module 335 which controls an operation of a traffic light, an illegal parking enforcement control module 336 detecting a illegal parking vehicle, and an exclusive bus lane enforcement control module 337 detecting a vehicle which violates an exclusive bus lane.

Specifically, a CCTV control module 331 may transfer a traffic situation to the outside in real time through an optical communication. Therefore, it is possible to monitor the traffic situation in a remote location (e.g., the traffic information center 130). For example, the CCTV control module 331 may transfer a traffic image signal by using a video streaming, and may control a fan-tilt included in the traffic information collecting device 111 (e.g., a camera).

The automatic vehicle identification (AVI) control module 332 may indentifies a license plate number of a driving vehicle in the traffic image signal. The configuration of indentify the license plate number may be implemented in a conventional algorithm for indentify a license plate number.

The vehicle detector (VDS) control module 333 may analyze a traffic volume based on the traffic image signal. For example, the vehicle detector (VDS) control module 333 may calculate a number of vehicles passing through each lane, a speed of the vehicles, an occupancy of the vehicles, and a type of vehicle.

The variable message sign (VMS) control module 334 may control the variable message sign (VMS) to display an information (e.g., a traffic situation, an incident information, an usable lane information, a weather information, etc) or delete a displayed information.

The element device controller 330 may include a reset module 338 to control a power which is supplied to a plurality of the control modules in response to a control of the integrated controller 350. For example, when one control module is not operated normally, the element device controller 330 may rest the control module by controlling a power supplied to the control module.

The output unit 340 may display a monitoring result of the element control modules generated by the integrated controller 350. For example, the output unit 340 may be implemented as a display device.

The integrated control device 120 may include an optical equipment unit 410 performing an optical communication and a terminal box unit 420 for a stable power supplying. Where, the terminal box unit 420 may include a circuit breaker, a surge protector and a battery (or, UPS).

The integrated controller 350 may monitor a plurality of the element device control modules, and the integrated controller 350 may generate a traffic management strategy to control a traffic flow in some areas in which the integrated control device 120 is located based on detecting signals generated by a plurality of the element device control modules.

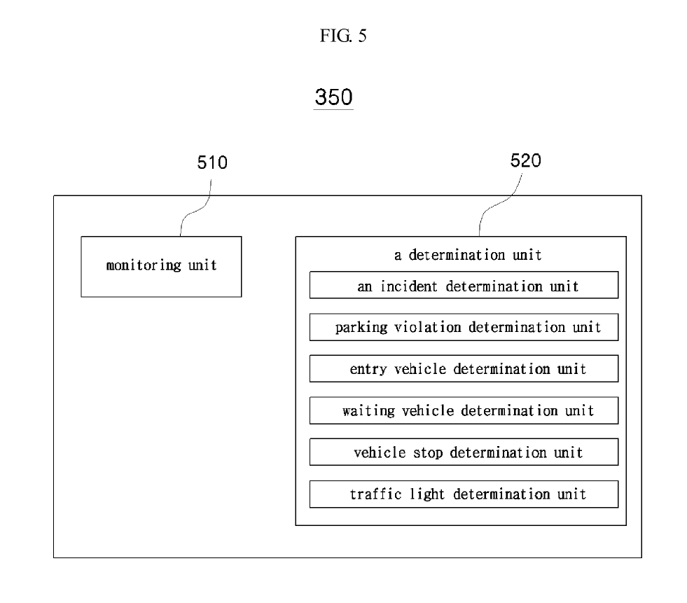

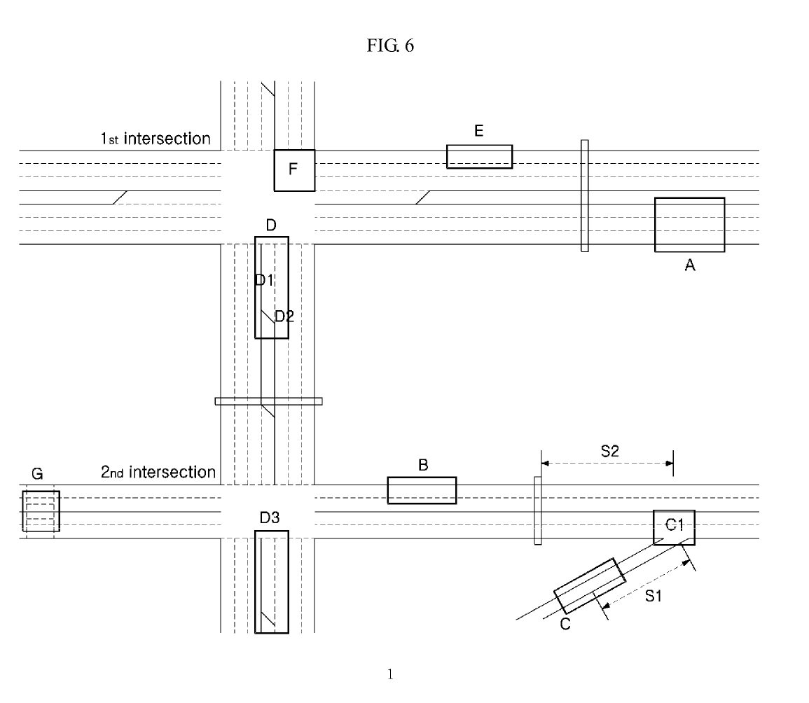

FIG. 5 is a block diagram illustrating an example of an integrated controller included in the integrated control apparatus of FIG. 3. FIG. 6 is a diagram for explaining a traffic management strategy which is generated by the integrated control apparatus of FIG. 3.

Referring to FIG. 5, the integrated controller 350 may include a monitoring unit 510 and a determination unit 520.

The monitoring unit 510 may identify each of the element device control modules, and the monitoring unit 510 may generate a control module status information by monitoring an operation of the element device control modules which is identified. When a control module is installed in the integrated control device 120, the monitoring unit 510 may automatically indentify the control module. The monitoring unit 510 may generate a control module status information by monitoring an operation of the control module in real time. When the control module fails, the monitoring unit 510 may generate a failure information and may transfer the failure information to the outside (e.g., the traffic information center 130).

The determination unit 520 may generate a traffic management strategy (or, a traffic management information) based on detecting signals generated by the element device control modules. The determination unit 520 may control the element device control modules based on the traffic management strategy.

Specifically, the determination unit 520 may include an incident determination unit, a parking violation determination unit, an entry vehicle determination unit, an waiting vehicle determination unit, and a vehicle stop determination unit. They are classified according to a function of the determination unit 520, the determination unit 520 is not limited thereto.

The incident determination unit may determine an occupancy of a vehicle in a area A described in FIG. 6. The incident determination unit may determine whether an incident occur based on the occupancy. For example, the incident determination unit may constantly track a plurality of vehicles, and the incident determination unit may determine an occupancy of each of the vehicles. The incident determination unit may determine whether the occupancy excess a predetermined reference occupancy and whether an occupied duration excess a predetermined reference duration, or the incident determination unit may determine whether a reverse driving duration of the vehicle excess a predetermined reference duration. The incident determination unit may generate an incident information based on the above conditions. The integrated control device 120 may control the traffic information displaying device 112 located within some distances from a point according to the incident information to display the incident information. Therefore, it is possible to prevent a secondary crash and to improve a traffic flow.

The parking violation determination unit may whether a vehicle is violated a parking regulation by comparing a location of the vehicle and a location of a predetermined first area. For example, the parking violation determination unit may determine whether the vehicle is in the predetermined first area (e.g., a parking prohibited area or a parking prohibited lane, illustrated in FIG. 6), and the parking violation determination unit may determine whether the vehicle is violated a parking regulation based on the occupancy of the vehicle and a duration of a occupied duration. When the above exemplary conditions are satisfied, the parking violation determination unit may generate a parking violation caution information in accordance with the vehicle violated the parking regulation. The integrated control device 120 may control the traffic information displaying device 112 located within some distances from a point according to the parking violation caution information to display the parking violation caution information. Therefore, it is possible to prevent an accident due to a sudden lane changing and a traffic bottleneck.

The entry vehicle determination unit may calculate a speed of a second vehicle which is recognized in a second area. The entry vehicle determination unit may generate an entry vehicle caution information by calculating a second arrival time of the second vehicle to get to a fourth area. Where, the fourth area may be a approach road that a second road including the second area meets a third road including a third area. The second area is a previous area space apart by some distances from the fourth area along a driving direction of the second vehicle. The third area is a previous area space apart by some distances from the fourth area along a driving direction of a third vehicle.

Referring to FIG. 6, the entry vehicle determination unit may calculate a speed V1 of a second vehicle recognized in a second area C. The entry vehicle determination unit may calculate a second arrival time T1 of the second vehicle based on a speed V1 of the second vehicle and a distance between the second area C and a fourth area C1. A distance S2 between the traffic information displaying device 112 and the fourth area and a reference speed V2 (or, a designed speed) of a third road in which the traffic information displaying device 112 is located may be pre-set. Therefore, the entry vehicle determination unit may calculate a third arrival time T2 that a third vehicle (e.g., a virtual vehicle) arrive in a fourth area based on the distance S2 and the reference speed V2. The entry vehicle determination unit may calculate a displaying daration of the entry vehicle caution information based on a between the third arrival time and the second arrival time.

For example, the entry vehicle determination unit may calculate the displaying duration of the entry vehicle caution information according to a first equation. The first equation may be written as:

Ta=T2−T1, (1)

T1=(S1/V1)*3.6, (2)

T2=(S2/V2)*3.6 (3)

Where, Ta=a displaying duration, T1=a arrival time from a detector to a main road (s), T2=a arrival time from displaying point to the main road (s), V1=a detected speed (km/h), and V2=a designed speed of the main road (km/h)

The traffic information displaying device 112 may be located in a point that the T1 is equal to the T2. The traffic information displaying device 112 may display the entry vehicle caution information during the displaying duration. Therefore, the integrated control device 120 may prevent a vehicle driving in a main road to conflict with a entry vehicle, any the integrated control device 120 may decrease a rapid acceleration of a vehicle, a rapid deceleration of the vehicle, and changing of lane. Therefore, a traffic safety would be improved.

The waiting vehicle determination unit may calculate a fifth occupancy of a fifth vehicle recognized in a fifth area which is pre-set. The waiting vehicle determination unit may generated a waiting vehicle caution information based on the fifth occupancy. For example, referring to area D illustrated in FIG. 6, some roads may include a waiting lane for a left turn(or, a right turn) for some sections (e.g., a section adjacent to an intersection). The waiting vehicle determination unit may set a start point of the waiting lane as a fifth area, and the waiting vehicle determination unit may calculate a fifth occupancy of the fifth vehicle recognized in the fifth area. When the fifth occupancy excess a predetermined reference occupancy, the waiting vehicle determination unit may determine that the waiting lane is exceeded and may predict that a traffic jam occurs in a lane (e.g., a first lane) associated with the waiting lane for left turn. When the above exemplary conditions are satisfied, the waiting vehicle determination unit may generated a waiting vehicle caution information associated with the lane (e.g., a first lane).

Similarly, the waiting vehicle determination unit may calculate a fifth occupancy of vehicles recognized in a predetermined fifth area. The waiting vehicle determination unit may generate a waiting vehicle caution information based on the fifth occupancy. That is, the waiting vehicle determination unit may generate a waiting vehicle caution information based on occupancies of a plurality of vehicles. The integrated control device 120 may control the traffic information displaying device 112 located within some distances from a point according to the waiting vehicle caution information to display the waiting vehicle caution information. Therefore, it is possible to prevent a deceleration and a sudden changing of a lane due to a waiting vehicle for a left turn (or, a right turn) and to improve a traffic safety.

In some example embodiments, the waiting vehicle determination unit may generate a vehicle guiding information based on a plurality of waiting vehicle caution informations. For example, when a waiting lane for a left turn in a downstream intersection D3 illustrated FIG. 6 is set as a bypass road for other waiting lane for a left turn in a upstream intersection D illustrated FIG. 6, the waiting vehicle determination unit may generate a vehicle guiding information based on waiting vehicle caution informations according to the waiting lanes. For example, when the waiting vehicle determination unit determines that a waiting lane in downstream is exceeded and a waiting lane in upstream is not exceeded, the waiting vehicle determination unit may generate a vehicle guiding information to display a status of the upstream by the traffic information displaying device 112 located adjacent to the downstream.

The vehicle stop determination unit may detect a vehicle number (or, a vehicle code, a license plate number of a vehicle) and may search a driving route of the vehicle based on the vehicle number, and may generate a vehicle stop caution information based on the driving route. For example, the vehicle stop determination unit may detect a vehicle number by using an image processing algorithm and may determine whether the vehicle is a public transportation (e.g., a bus) based on the detected vehicle number. When the vehicle is a bus, the vehicle stop determination unit may search a driving route (e.g., a bus route) of the vehicle from a database or some servers. The vehicle stop determination unit may determine a stop position of the vehicle. That is, the vehicle stop determination unit may determine whether the vehicle is stop in some areas based on a driving route according to the vehicle. The integrated control device 120 may control the traffic information displaying device 112 located within some distances from a point according to the vehicle stop caution information to display the vehicle stop caution information. Therefore, it is possible to prevent a deceleration and a sudden changing of a lane of a vehicle which drives along behind a bus and to improve a traffic safety.

In some example embodiments, the vehicle stop determination unit may detect a vehicle number and may generate a changing lane information for a vehicle that a driving route is not searched based on the vehicle number. For example, when the vehicle stop determination unit determines that a vehicle is not a public transportation (e.g., a bus), the vehicle stop determination unit may generate a changing lane information for the vehicle to change a lane. The integrated control device 120 may control the traffic information displaying device 112 located within some distances from a point according to the changing lane information to display the changing lane information. Therefore, it is possible to improve a driving environment of a public transportation.

According to example embodiments, the determination unit 520 may generate an incident information, a parking violation information, an entry vehicle caution information, a waiting vehicle caution information, a vehicle stop caution information, and a changing lane information. The traffic information displaying device 112 may display the informations. Therefore, the integrated control system 100 may manage and control a traffic flow.

The traffic light determination unit may calculate an occupancy of a vehicle and may generate a traffic light control information to control the traffic light 113 based on the occupancy.

The traffic light determination unit may set a crossroad as a vehicle identification area. The traffic light determination unit may calculated an occupancy of a vehicle in the vehicle identification area. The traffic light determination unit may generate a traffic light control information based on the occupancy.

Referring to FIG. 6, when a driving light for a north direction in a first crossroad (e.g., an area F) is red and a vehicle moving to the north direction occupies the first crossroad, there is a problem that a vehicle to drive from east to west may not move. For one example, the traffic light determination unit may set the first crossroad as a vehicle identification area, and the traffic light determination unit may identify vehicles moving toward the north direction based on a traffic light of a north direction (e.g., a time in which a green light changes a red light). The traffic light determination unit may calculate an occupancy of the vehicles and may predict a time required to leave the first crossroad (or, the vehicle identification area). The traffic light determination unit may generate a first traffic light control information for the traffic light 113 in the first crossroad to display an all-red signal that all vehicles to drive toward all direction stop in the predicted time. Therefore, the integrated control device 120 may solve a congestion problem such as moving violation in a crossroad.

For other example, the traffic light determination unit may recognize vehicles driving toward the north direction and may calculate an occupancy of the vehicles. The traffic light determination unit may predict that a congestion in a crossroad and may generate a second traffic light control information to control an operation of the traffic light 113. Therefore, the integrated control device 120 may detect a moving violation in advance and may prevent being congested crossroad.

The traffic light determination unit may calculate a traffic volume based on a identified vehicles and may change an operation time of a flashing traffic light. For example, the traffic light determination unit may calculate a traffic volume in some roads based on vehicles which are identified during some period (e.g., a fifteen minute). When a traffic volume excesses a predetermined reference traffic volume (e.g., 600 vehicles per hour), the traffic light determination unit may extend an operation period of a driving traffic light of the traffic light 113.

The traffic light determination unit may calculate a road crossing time for some objects based on an occupancy of the some objects that cross a road. For example, the traffic light determination unit may set a crosswalk as an object identification area and may identify a pedestrian crossing the crosswalk. The traffic light determination unit may calculate an occupancy of the pedestrian and a moving speed of the pedestrian based on the occupancy. The traffic light determination unit may calculate a road crossing time of the pedestrian based on the moving speed and a length of the crosswalk (or, a width of a road). The traffic light determination unit may change an operating time of the traffic light 113 of the crosswalk based on the road crossing time. The traffic light determination unit may extend a red traffic light for a vehicle considering a walking speed of the handicapped (e.g., children, the old, etc). Therefore, the integrated control device 120 may improve a pedestrian safety.

The traffic light determination unit may identify a pedestrian crossing a road (or, a crosswalk) and may generate a traffic light control information that all traffic light of all traffic light 113 for vehicles become a flashing traffic light. Specifically, at night time that the traffic light 113 is operated in a flickering signal, the traffic light determination unit may generate a traffic light control information traffic lights of all traffic light 113 become red flickering signal by indentifying a pedestrian crossing a road. Therefore, the integrated control device 120 may cause drivers to drive with cautions and may improve a pedestrian safety.

The integrated control device 120 according to some example embodiments may identify an object and determine a traffic status based on a received traffic information. The integrated control device 120 may generate a traffic management information (e.g., an incident information, a parking violation information, etc), and the integrated control device 120 may control the traffic information displaying device 112 to display the information or may control an operation of a traffic light of the traffic light 113 by generating a traffic light control information. Therefore, the integrated control device 120 may improve a driving safety of a vehicle and may prevent an occurrence of a traffic congestion. And, the integrated control device 120 may improve a pedestrian safety by changing an operation of the traffic light 113.

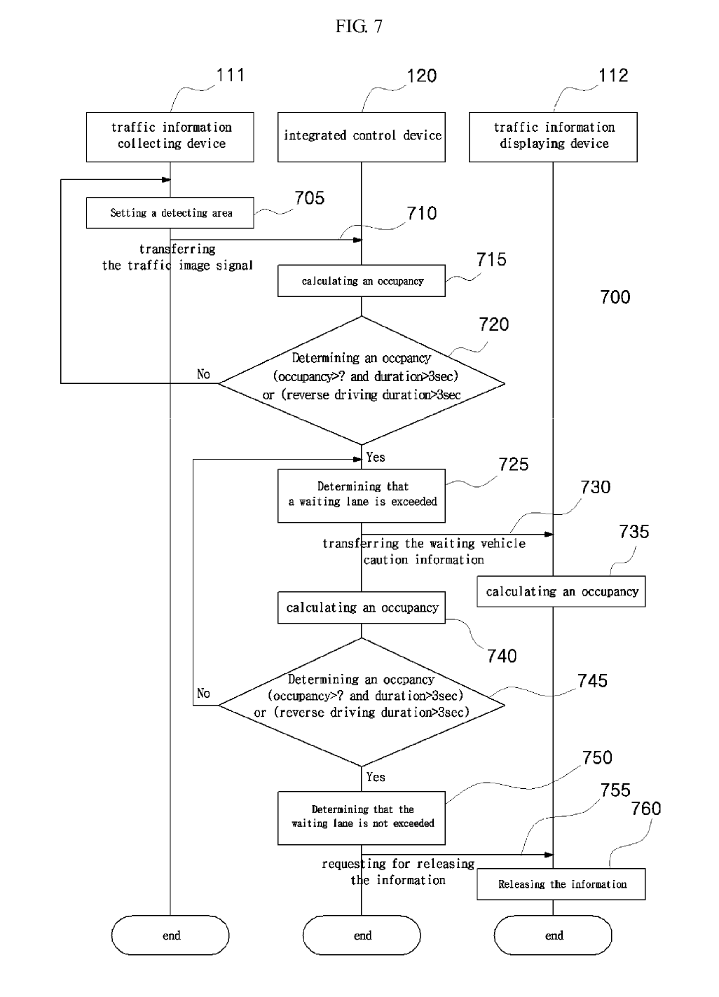

FIG. 7 is a flow chart illustrating an waiting vehicle caution information generated by the integrated control apparatus of FIG. 3.

Referring to FIGS. 6 and 7, the traffic information collecting device 111 may set (Step S705) a detecting area. As illustrated in FIG. 6, the traffic information collecting device 111 may set an area D as a detecting area. The traffic information collecting device 111 may acquire a traffic image signal and may transfer (Step S710) the traffic image signal to the integrated control device 120.

The integrated control device 120 may identify a vehicle based on the traffic image signal and may calculate (Step S720) an occupancy of the vehicle. For example, the integrated control device 120 may separate an area D into an area D1 which is a waiting lane for a left turn and an area D2 is adjacent to the area D1. the integrated control device 120 may indentify vehicles in the areas D1 and D2 and may calculate an occupancy of each of the vehicles.

The integrated control device 120 may determine whether the occupancy is within a certain range and may determine (Step S725) that the waiting lane is exceeded. For example, when an occupancy of the area D1 is more than x% and an occupancy of the area D2 is more than y%, the integrated control device 120 may determine that the waiting lane is exceeded.

Thereby, the integrated control device 120 may generate a waiting vehicle caution information and may transfer (Step S730) the waiting vehicle caution information to the traffic information displaying device 112. The traffic information displaying device 112 may display a waiting vehicle caution message such as “lane ahead is congested, driving carefully.” based on the waiting vehicle caution information.

The integrated control device 120 may detect a vehicle in the area D and may continuously calculate (Step S740) an occupancy of the vehicle. The integrated control device 120 may determine (Step S750) whether the waiting lane is exceeded based on the calculated occupancy. When, the waiting lane is not exceeded (Step S750), the integrated control device 120 may generate a request signal for releasing a waiting vehicle caution and may transfer (Step S755) the request signal to the traffic information displaying device 112. The traffic information displaying device 112 may delete (Step S760) the caution message in response to the request signal.

The present embodiments may be applied to any control system for controlling a traffic.

The foregoing is illustrative of example embodiments, and is not to be construed as limiting thereof Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. An integrated control device of ITS device comprising:
an element device controller including a plurality of element device control modules, the element device control modules configured to perform an operation set in advance based on a traffic image signal provided from at least one image acquisition device; and
an integrated controller configured to monitor the element device control modules and configured to generate a traffic management strategy to control a traffic flow in some areas based on the operation of the element device control modules.

2. The method of claim 1, wherein each of the element device control modules includes one selected from among a CCTV control module which transfers the traffic image signal to an outside, an automatic vehicle identification (AVI) control module which indentifies a vehicle based on the traffic image signal, a vehicle detector (VDS) control module which analyzes a traffic volume based on the traffic image signal, a variable message sign (VMS) control module which controls an operation of a variable message sign (VMS), a traffic light control module which controls an operation of a traffic light, an illegal parking enforcement control module detecting a illegal parking vehicle, and an exclusive bus lane enforcement control module detecting a vehicle which violates an exclusive bus lane.

3. The method of claim 2, wherein the element device controller further includes a reset module configured to control a power which is supplied to the control modules in response to a control of the integrated controller.

4. The method of claim 1, wherein the integrated controller is configured to indentify each of the element device control modules and is configured to generate a control module status information by monitoring an operation of the element device control modules which is identified.

5. The method of claim 1, wherein the integrated controller is configured to generate the traffic management strategy based on detecting signals which is generated from the element device control modules and is configured to control a variable message signal or a traffic light selected from the element device control modules based on the traffic management strategy.

6. The method of claim 1 further comprising an environmental monitoring unit which includes a sensing module to sense a temperature inside of the integrated control device and a cooling heating module to adjust an interior temperature based on a sensed temperature.

7. The integrated control system comprising a plurality of integrated control devices of ITS devices which are connected to a traffic information acquisition device, a traffic information display device, and a traffic information center through a network, where a n-th (where, n is an integer of 2 or more) integrated control device among a plurality of the integrated control devices includes:
a communication unit configured to receive a traffic image signal provided from the traffic information acquisition device, a traffic management information provided from a integrated control device which is located adjacent to the n-th integrated control device, and a traffic control information provided from the traffic information center;
an element device controller including a plurality of element device control modules, the element device control modules configured to perform an operation set in advance based on the traffic image signal; and
an integrated controller configured to monitor the element device control modules and configured to generate a n-th traffic management strategy to control a traffic flow in some areas based on one selected among the operation of the element device control modules, the traffic management information, and the traffic control information.
